(19) United States
(12) Patent Application Publication
(10) Pub. No.: US 2004/0015444 A1
(43) Pub. Date: Jan. 22, 2004

(54) Method and apparatus for controlling use of or access to electronic content

(76) Inventor: Wilson How Kiap Gueh, Singapore (SG)

Correspondence Address: FOLEY & LARDNER, 321 NORTH CLARK STREET, SUITE 2800, CHICAGO, IL, 60610-4764, US

(21) Appl. No.: 10/276,903

(22) PCT Filed: May 18, 2001
(86) PCT No.: PCT/SG01/00095

(30) Foreign Application Priority Data
May 19, 2000 (SG) 200002753-2

(51) Int. Cl. G06F 17/60

(52) U.S. Cl. 705/51

(57) ABSTRACT

The present invention provides a method and apparatus for controlling the use of or access to electronic content, the method comprising the steps of: specifying for the content a cost expressed in terms of computing units; selling to a user a number of the computing units; and permitting the user to use or access the content as long as the user has a positive balance of the computing units.

### FIELD OF THE INVENTION

The present invention relates to a method and apparatus for controlling the provision or use of electronic content, or access thereto, and is of particular but by no means exclusive application in the provision of software and other content (such as motion picture, audio/music/video recordings, computer software, computer games, and computer console games) over a computer network.

Conventionally, purchasers of computer software have been required to buy—often at substantial cost—the various required computer programs from various software vendors. A desktop publishing company, for example, may have to purchase an office productivity suite, a desktop publishing software, an accounting and database suite, etc., at a cost of several thousand dollars.

Other users of electronic content (such as computer games) must generally also spend substantial sums ownership costs in purchasing the copies of that content, even though—in the case of a computer game—a user is likely not to play the same game after a time period.

Such a situation can encourage software piracy which, despite anti-piracy protection built-in into many software and hardware appliances (e.g. game consoles, VCD/DVD players, etc.), flourishes owing to the huge demand for pirated software. As a result, software pirates develop highly advanced schemes to overcome the anti-piracy protection devices. There are many such mechanisms (including legal, hardware or software), including encryption schemes, and digital rights assignment technology that aims to control and ensure the authorized use and access of electronic content. All have varying degrees of success, as any such measures (including their existence itself) increase the cost of the software, and consumers do not want to pay a high cost of ownership for using/accessing electronic content.

Further, in the case of computer software, high retail prices can make changing to an alternative manufacture's software excessively expensive and, as a result, users often feel effectively locked into the first choice of software (e.g. word processor) even though it may prove less than ideal: it is less expensive to live with one's mistakes. High costs of ownership thus creates a problem of inflexibility for users of electronic content/software because they cannot switch between a wide range of contents/software.

More recently, with the advent of the Internet and of Application Service Providers (ASPS), users of computer software can access computer software and/or electronic content via the Internet by paying an access fee (either once or periodically, such as monthly).

However, to make use of the above mentioned ASP content over the internet, and to achieve a comparable performance and speed level to that of the same software as installed on a desktop computer, the user is required to maintain a high speed Internet connection, which can be expensive.

Furthermore, security is a potential problem to users (particularly business users) when a constant Internet connection is required to run critical/core business applications. This means that ASP based software delivery systems can present problems relating to speed, performance and security relative to a desktop/server centric computing model.

Software vendors have tried to reduce or downplay these effects by packaging the same software in suites at different prices for different consumer groups. For example, office productivity software (MS Office brand software) is provided by Microsoft Corporation at different prices to different consumer types, by combining different sets of individual software packaged into different versions, referred to as “Professional”, “Standard”, etc. The software reduces the cost of the software for some users, but does not eliminate the fundamental problem of expense and inflexibility.

In addition, much software incorporates an ever increasing number and complexity of features. Some users find that the cost of such software is excessive in view of the limited proportion of the software's abilities actually used.

### SUMMARY OF THE INVENTION

It is object of the present invention to provide a system for regulating access to electronic content by allowing users to purchase a predetermined quantum of access.

The present invention provides, therefore, a method of controlling the use of or access to electronic content, comprising the steps of:

specifying for said content a price expressed in computer units, said computer units being useable to purchase usage of one or more computers to use or access said content;

selling to a user a number of said computer units; and

permitting said user to use or access said content as long as said user has a positive balance of said computer units;

whereby said user purchases said usage with one or more of said computer units.

In a preferred embodiment said content is a computer program or a function within a computer program.

Thus, in this embodiment, the user buys a number of computer units, and the price of a single use or access is expressed in terms of those computer units. For example, a single session of using a computer program (such as a word processor) might cost “n” computer units, while the cost of a single play of a computer game or video recording “m” computer units.

Preferably the method includes advising said user of said price before permitting said user to use or access said content and, if said user has sufficient computer units to use or access said content, said method includes accepting from said user acceptance or refusal of said price and thereby use of or access to said content, or, if said user has insufficient computer units to use or access said content, said method includes accepting from said user acceptance or refusal of said price and selling to said user sufficient computer units to use or access said content if said user accepts said price.

Preferably said method includes selling additional computer units to said user to increase said balance.

Preferably said method includes accepting a request from said user for said content, and providing authorization data to said user if said user has a sufficient number of said computer units to use or access said content, whereby said authorization data is useable to permit use of or access to said content.

Preferably said method includes monitoring use of or access to said content by said user by means of monitoring means in a device employed by said user to use or access said content, requesting that additional computer units be purchased if said balance is insufficient for a requested use of or access to said content, and terminating or denying said use or access when said user has an insufficient balance.

Preferably said method includes transmitting said authorization data to said device, wherein said device is operable to permit said use or access in response to receiving said authorization data.

Preferably, when said device is a computer, said monitoring means comprises software executable on said computer.

Preferably said method includes calculating said price according to said user's previous use of said content or of other associated content.

Preferably said method includes recording, for each user, the sale of said computer units and the use of or access to any of said content.

The present invention also provides a method of controlling the use of or access to electronic content, comprising the steps of:

specifying for said content a price expressed in computer units, said price corresponding to either:

1) a number of uses of or accesses to said content by means of one or more computers; or

2) a net duration of use of or access to said content by means of one or more computers;

selling to a user a number of said computer units; and

determining the available number of said computer units available to said user;

permitting said user to purchase a quantity of said use or access of said content with said available number of computer units.

Thus, a user can pay for (or order and be billed for) a fixed number of computer units for use of the content. This may correspond to using the content a fixed number of times, or having access to the content for a fixed net duration (i.e. not a period—such as a month—during which the user may access the content any number of times, but rather a net processing or access time). The term content refers to any form of electronic content. In some cases it may refer to a computer application, in other cases to a single function of such an application. It should be noted that the number of available computer units may be less than the number of computer units bought by the user, as the user may have used some of those computer units in the interim.

Preferably said method includes setting said number of computer units that may be ordered or paid for by said user. Alternatively, the method includes additionally accepting from said user a specification of a desired number of computer units.

Preferably said method includes selling additional computer units to said user to increase said available number of computer units.

Preferably said method includes accepting a request from said user for said content, and providing authorization data to said user if said user has a sufficient number of said computer units to use or access said content, whereby said authorization data is useable to permit use of or access to said content.

Thus, said content may be stored locally, but be disabled until a user provides suitable authorization data (such as a password).

Preferably said method includes transmitting said authorization data to said device, wherein said device is operable to permit said us or access in response to receiving said authorization data.

Preferably said method includes monitoring said use or access by means of monitoring means in a device employed by said user to use or access said content, and terminating use of or access to said content when said user has exhausted said available number of computer units or otherwise has insufficient computer units to continue said access or use.

Preferably, when said device is a computer, said monitoring means comprises software executable on said computer.

Preferably said method includes calculating a price for said use or access according to said user's previous use of said content or of other associated content.

Preferably said method includes recording, for each user, the sale of said computer units and the use of or access to any of said content.

In one embodiment, the method includes providing to said user said use of or access to said electronic content by means of an intermediary. Preferably the method includes paying said intermediary for providing to said user said use of or access to said electronic content.

Preferably the method includes being billed by said intermediary for providing to said user said use of or access to said electronic content on the basis of computer units spent by said user in the course of receiving said use of or access to said electronic content by means of an intermediary.

Preferably the intermediary is notified that said user desires said use of or access to said electronic content by said user attempting to establish a connection to a server of said intermediary by means of a modified user identification information, unmodified user identification information being that user identification information used by said user when seeking use of or access to said electronic content without said intermediary.

Preferably the modified user identification information comprises said unmodified user identification information with additional characters appended to a user name, to a password or to both a user name or to a password. More preferably the additional characters comprise or include characters indicative of the user's country of origin in which said unmodified user identification information is valid.

In another embodiment, the method includes monitoring use of or access to said content by said user by means of monitoring means in a device employed by said user to use or access said content, by means of monitoring means contained in said content, or by means of monitoring means in said device and contained in said content.

Preferably the method includes monitoring said use of or access to said content when said user is off-line, wherein said monitoring means is provided with information indicative of said balance of said computing when last said user was on-line.

Preferably the monitoring means comprises software portions.

The present invention also provides an apparatus for controlling the use of or access to electronic content, comprising:

computing means including input means for receiving from a user an order for a number of computer units, said computer units being useable to purchase usage of one or more computers to use or access said electronic content, payment for said numb r of said computer units and a request for said use of or access to said content;

memory storage means for storing a price for said content expressed in computer units, and for storing credit data for determining the number of said computer units available to said user for purchasing said usage or access;

authorization means for authorizing said use of or access to said content;

wherein said computing means is operable to receive said request, check said credit data and direct said authorization means to authorize said use of or access to said content as long as said user has a positive balance of said available computer units for purchasing said usage or access.

In a preferred embodiment said content is a computer program or a function within a computer program.

Preferably the computing means is operable to advise said user of said price before directing said authorization means to authorize said use or access and, if said user has sufficient available computer units to use or access said content, to accept from said user acceptance or refusal of said price and thereby use of or access to said content, or, if said user has insufficient available computer units to use or access said content, to accept from said user acceptance or refusal of said price and sell to said user sufficient computer units to use or access said content if said user accepts said price.

Preferably said apparatus is operable to accept an additional order and/or payment from said user to increase said balance.

Preferably said apparatus is operable to monitor use of or access to said content by said user by means of monitoring means in a device employed by said user to use or access said content, to request that additional computer units be purchased if said balance is insufficient for a requested use of or access to said content, and to terminate or deny said use or access when said user has an insufficient balance.

Preferably said apparatus is operable to transmit authorization data to said device, wherein said device is operable to permit said use or access in response to receiving said authorization data.

Preferably, when said device is a computer, said monitoring means comprises software executable on said computer.

Preferably said computing means is operable to calculate said price according to said user's previous use of said content or of other associated content.

Preferably said apparatus is operable to record, for each user, the sale of said computer units and the use of or access to any of said content.

The present invention still further provides an apparatus for controlling the use of or access to electronic content, comprising:

computing means including input means for receiving from a user an order for a number of computer units and/or payment for said number of said computer units, and a request for said use of or access to said content, said computer units being useable to purchase usage of said content and each of said computer units corresponding to either: 1) a number of uses of or accesses to said content by means of one or more computers; or 2) a net duration of use of or access to said content by means of one or more computers;

memory storage means for storing credit data for determining the number of said computer units available to said user for purchasing said usage or access;

authorization means for authorizing said use of or access to said content;

wherein said computing means is operable to receive said request, check said credit data, and direct said authorization means to authorize a quantity of said use or access according to said number of computer units available to said user.

Preferably said computing means is operable to accept said order only in respect of a predetermined number of said computer units. Alternatively, the computing means is operable to accept said order in respect of a number of said computer units specified by said user.

Preferably said computer means is operable to accept an additional order and/or payment from said user to increase said available number of computer units.

Preferably said apparatus is operable to provide authorization data to said user if said user has a sufficient number of said computer units to use or access said content, whereby said authorization data is useable to permit use of or access to said content.

Preferably said apparatus is operable to monitor said use or access by means of monitoring means in a device employed by said user to use or access said content, and to terminate use of or access to said content when said user has exhausted said number of computer units or otherwise has insufficient computer units to continue said access or use.

Preferably said apparatus is operable to transmit said authorization data to said device, wherein said device is operable to permit said use or access in response to receiving said authorization data.

Preferably, when said device is a computer, said monitoring means comprises software executable on said computer.

Preferably said apparatus is operable to calculate said a price for said use or access according to said user's previous use of said content or of other associated content.

Preferably said computing means is operable to record, for each user, the sale of said computer units and the use of or access to any of said content.

In one embodiment, the apparatus is operable to provide to said user said use of or access to said electronic content by means of an intermediary.

Preferably the apparatus is operable to pay said intermediary for providing to said user said use of or access to said electronic content.

Preferably the apparatus is operable to be billed by said intermediary for providing to said user said use of or access to said electronic content on the basis of computer units used by said user in the course of receiving said use of or access to said electronic content by means of an intermediary.

Preferably the intermediary is notified that said user desires said use of or access to said electronic content by said user attempting to establish a connection to a server of said intermediary by means of a modified user identification information, unmodified user identification information being that user identification information used by said user when seeking use of or access to said electronic content without said intermediary.

Preferably the modified user identification information comprises said unmodified user identification information with additional characters appended to a user name, to a password or to both a user name or to a password. More preferably the additional characters comprise or include characters indicative of the user's country of origin in which said unmodified user identification information is valid.

In another embodiment, the apparatus is operable to monitor use of or access to said content by said user by means of monitoring means in a device employed by said user to use or access said content, by means of monitoring means contained in said content, or by means of monitoring means in said device and contained in said content.

Preferably the apparatus is operable to monitor said use of or access to said content when said user is off-line, wherein said monitoring means is provided with information indicative of said balance of said computing when last said user was on-line.

### BRIEF DESCRIPTION OF THE DRAWINGS

In order that the invention may be more clearly ascertained, preferred embodiments will now be described, by way of example, with reference to the accompanying drawings, in which:

FIG. 1a is a schematic view of a window on a user's computer, of an apparatus for controlling the use of computer applications on a user computer according to a preferred embodiment of the present invention;

FIG. 1b is a schematic view of the window of FIG. 1b after a user has requested the use of on an application;

FIG. 2a is a schematic view of an application window on a user's computer, of an apparatus for controlling the use of computer applications on a user computer according to a second preferred embodiment of the present invention;

FIG. 2b is a schematic view of the window of FIG. 2b after a user has requested the use of a function of the application;

FIG. 3 is a schematic view of a Dial-up Connection window for establishing a connection to a local or foreign server according to either preferred embodiment of the present invention.

### DETAILED DESCRIPTION OF THE PREFERRED EMBODIMENTS

An apparatus for controlling the use of electronic content, in the form of computer applications on a networked user computer according to a preferred embodiment of the present invention includes controller software loadable onto and executable on the user's computer and server software loadable onto and executable on a vendor's web server accessible by the user's computer over the internet. The controller software may be either a stand-alone program, or portions of code embedded within the software applications controlled by the apparatus. In the following description, it should be understood that access by the user to the functions of the server software (such as for the purchase of “computing units” as discussed below) requires the use of a username/password combination.

The controller software monitors and controls any attempt by a user to use those programs governed by the system, whether those computer applications are located on the user's computer or the networked system computer of the vendor (typically an ASP). In an alternative embodiment, such applications are located on the vendor's web server. The applications themselves are versions of existing applications modified so that some or all of the functionality can be controlled by the controller software.

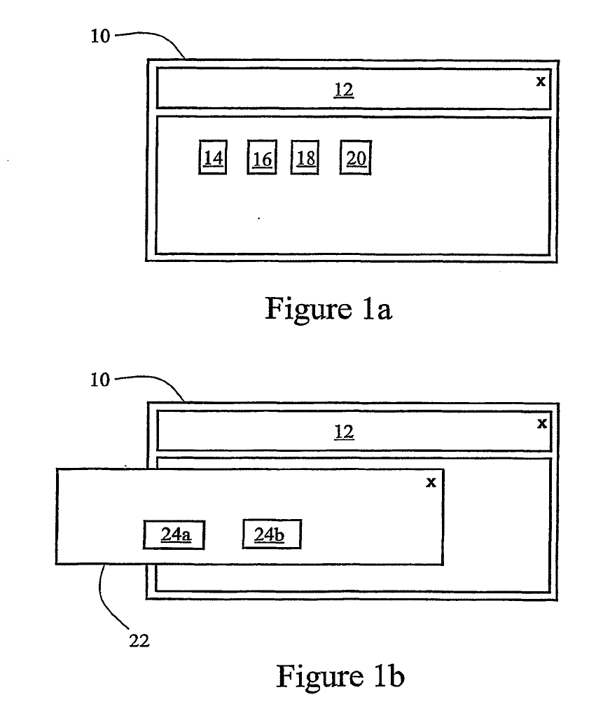

FIG. 1a is a schematic representation of a window 10 displayed on this screen of the user's computer, including a control bar 12 and application icons 14, 16, 18 and 20. Each application 14, 16, 18, 20, being examples of electronic content, can be used by the user only after the user has purchased access to that application. This is done in the following manner: the user pays for one or more “computer” or “computing” units at a specified price per unit. At the same time, each application 14, 16, 18, 20 has a specified price expressed in terms of “computing units per use”, “uses per computing unit”, “duration of use per computing unit” or “number of computing units per desired duration of use.”

Each of these applications 14, 16, 18, 20 is monitored by the controller software such that, if a user selects any one of these applications 14, 16, 18, 20, an query box 22 (see FIG. 1b) is opened by the controller software.

Query box 22 specifies the cost of using the requested application 14 expressed in terms of computing units, and enquires whether the user wishes to continue and expend that number of computing units. The user then either agrees by clicking on the OK button 24a or declines by clicking on the Cancel button 24b.

If the user selects Cancel button 24b, query box 22 is cancelled and the screen reverts to the configuration depicted in FIG. 1a. If, however, the user selects OK button 24a, the controller software attempt to establish an internet connection with the vendor's web server and, if the user has a credit balance equal to or greater than this cost, updates the user's credit balance. If not, the user is either prompted to pay for the required number of computing units, or is automatically billed for the number of computing units required to lift the user's balance of computing units to the necessary level. The web server is configured to then transmit authorization data in the form of a key to the user computer: the key is readable by the controller software and acts as a password, instructing the controller software to permit the user to use the desired application 14 as agreed. The key may be transmitted in any suitable form; in the preferred embodiment, however, it is transmitted over the internet from the web server to the user computer in a user profile file. Full details of the user's purchases of computing units and expenditure of those units (including specifying how many units were expended on what application or function) are retained in a master user profile stored on the web server, and available for billing or accounting purposes. Some or all of these details may also be transmitted to the user computer, such as in the user profile file containing the key (as described above).

In an alternative embodiment, the steps of checking the balance and requesting that the user purchase additional computing units if the balance is inadequate is conducted entirely on the user's computer provided that the user's profile indicates that the user has a sufficient balance of computing units to use the desired application. If not, an internet connection to the web server is established and the transaction proceeds as described above.

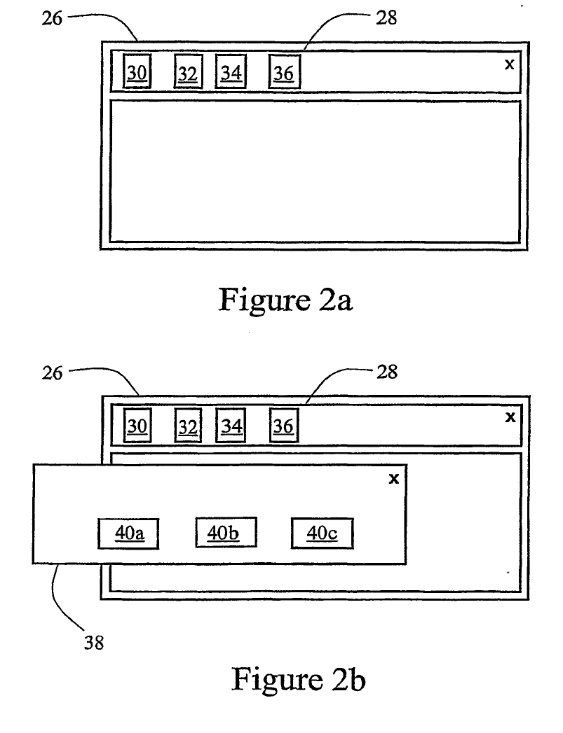

In a second preferred embodiment, the apparatus permits access to an application without initially charging computing units, but informing the user of the cost of each function of the application progressively (and obtaining the user's acceptance of that cost). Referring to FIGS. 2a and 2b, once an application has been opened, the user's computer screen displays, in the usual manner, an application window 26. Window 26 includes an application control bar 28 with function icons 30, 32, 34 and 36. In this example the application is a word processing application, and these function icons 30, 32, 34, 36 correspond to file opening, file saving, document printing, spell checking functions.

Although the controller software of the apparatus of the present invention will permit the user to use this program without purchasing or consuming computing units, if the user wishes to use any of the more advanced functions, such as the spell checker, and the user selects the corresponding spell checking function icon 36. The user is then presented with a query box 38 (similar to query box 22 of FIGS. 1a and 1b) specifying the cost in computing units of the requested function, and enquiring whether the user wishes to continue. The user can then click on Yes button 40a, No button 40b or Cancel button 40c. Query box 38 will also indicate the user's total expenditure of computing units since commencing using the application.

If the user clicks on the Yes button 40a, the requested function will be performed and the cost in computing units specified in query box 38 added to the progressive cost of using the application.

When the user has finished using the application and attempts to save the results and exit, the controller software will display a query box similar to query box 38 indicating the total number of computing units consumed during the use of the application and enquiring whether the user wishes to continue. If the user selects the Yes button, indicating that the user wishes to continue including paying for the use of the function, the apparatus establishes an internet connection with the web server and deducts the consumed computing unit from the user's credit balance or, if the existing credit balance is insufficient, updates the user's account or requests suitable payment. In the last case, if suitable payment is not forthcoming the user will not be able to save the results of his or her use of application and will be obliged either simply to terminate the application without saving those results or, indeed, provide suitable payment.

In all cases, payment is provide by inserting credit card details when prompted by the system computer, or initially establishing an account and indicating that any requested payment should or should not be billed to that account.

Thus, in each embodiment, when the consumer pays a specified amount of money, a pre-determined corresponding number of computing units are credited into the consumer's account for use.

Each time the consumer uses or accesses a product that triggers or is monitored by the controller software, the controller software automatically debits the appropriate amount of computing units from the user's account.

The applications compatible with the system can be used or accessed via two main methods:

1) the application to be used or accessed is stored, run or operated locally on the user's computer (games console, etc,); and

2) the application to be used or accessed is stored, run or operated via a computer network or the internet such as in a client-server or ASP computing model. This allows the electronic content to be accessed or used by consuming computing units as described above.

It will be understood that, although the foregoing description refers to content in the form of computer applications used on a user's computer, the electronic content can take any form including DVD motion pictures, audio soundtracks, etc. The appropriate controller is, in each case, provided in the corresponding hardware, be it a computer or other networkable device. The key (referred to above) need not be contained in a data packet transmitted from one computer to another but could be transmitted in any suitable form, such as an electrical, radio, microwave or photonic signal, over the airwaves, telephone system or otherwise. If, for example, the device were a television, the key could be transmitted as a radio frequency television signal.

Thus, the apparatus of the present invention provides the user with an incentive to buy only authorised copies of electronic content, since the ownership cost (discussed above) can be reduced owing to the apparatus's charging according to use.

In addition, the apparatus reduces the risk of piracy as:

1) software compatible with apparatus will only operate with the purchase of computing units, and

2) computing units are issued only in a manner that is either impossible to mimic or copy, or at least traceable. Thus, in the preferred embodiments, computing units are distributed only via the individual users accounts of the vendors; these accounts are similar to Internet Service Provider (ISP) accounts, where a user must submit secure user ID and password information to use the service. Any unauthorized production or crediting of computing units in a vendor's web server would have to be to a current or new user's account, which the vendor can readily monitor and track.

The apparatus may also be used remotely. Typically, in order to use the apparatus, a user would access the internet using his or her ISP and then establish a connection to the web server of the vendor of the electronic content. However, difficulties may arise if the user wants to access electronic content (whether the internet as such or other content on the world wide web) from other than his or her home country where the user has a relationship with an ISP. The user would ordinarily have to buy internet access from some other ISP, through an internet cafe or the like and go to the vendor's web site to be authenticated, before he or she can commence using any remaining computing units.

According to this embodiment of the present invention, however, a user is able to use computing units via another ISP (and therefore while in another country) in the following manner.

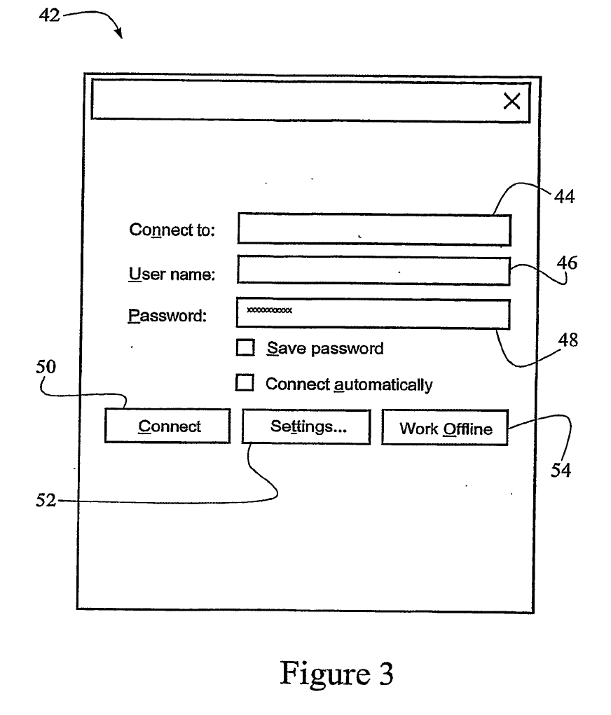

Referring to FIG. 3, either when in another country or merely if telephone dial-up connections to his or own home ISP are congested, the user dials-up for internet access in the same way as referred to above, except that the user dials-up another ISP. On whatever device being used (whether desktop, WAP, palmtop or otherwise), the user is presented with a Dial-up Connection window 42, with input fields for inputting server name 44, user name 46 and password 48. The window 42 also has activation buttons for then initiating a connection 50f modifying settings 52 and working off-line 54.

In practice, server name input field 44 may instead comprise a pull-down menu listing the servers available from that location.

The user, if at home, would enter his or home ISP, his under name and password in the usual manner. When in another country, the user enters or selects the name of a local (that is, foreign) ISP server in server input field 44, his or her usual (home) user name with a country of origin indicator appended to the user name in user name input field 46, and—in password input field 48—his or her usual password. This country of origin indicator comprises a full stop followed by a two letter code indicative of the user's country of origin.

As will be appreciated, in an alternative arrangement the user could be required to append the country of origin indicator to the password rather than to the user name.

For example, if the country of origin of the user were Singapore, he might have a home ISP server named “StarHub”, a user name “Tan_ah_Teck” and the password “password”. In Singapore he would enter, in fields 44, 46 and 48 respectively, “StarHub”, “Tan_ah_Teck” and “password”. When in the United States of America, however, he “America Online”, “Tan_ah_Teck.sg” and “password”.

These country of origin indicators are pre-arranged with the user's original ISP and the foreign (or alternative) ISP. The latter provides this service to and by arrangement with the original ISP. When the user in exploiting this feature merely owing to congested dial-up lines, the appended country of origin indicator makes it apparent to the other domestic ISP server what the user wishes to do.

When the foreign ISP access server recognizes that such incoming authentication data contains an appended country of origin indicator and that the user is therefore not a “local” dial-up customer, the foreign ISP server routes the request to the original ISP concerned (in this example in Singapore). It then waits for the original ISP server to reply and to confirm that the user has a positive available computing unit balance), before proceeding to allow access to the user.

The user, once granted access by the foreign ISP, can access the Internet, download files (such as a MP3 file), etc. The foreign ISP and the original ISP then contra bill each other based on such computing units.

According to this embodiment, the user may frequently desire to use downloaded content while off-line, after successfully gaining internet access. He or she may, for example, may have downloaded an MP3 file to a portable MP3 player; the user would not be expected to maintain that player online or connected to the internet during its subsequent operation.

Consequently, the controller software, residing on the user device or—in this example—the MP3 player, and preferably the downloaded MP3 file itself, have an internal timer that regulates the duration or number of times the file is being used, accessed or read by the MP3 player. The timer is provided with the number of computing units remaining when the user was on-line so that the content can only be used off-line until the computing units are exhausted. When the user is next on-line, the record of available computing units is again synchronized between controller software and the vendor's server software.

As will be understood by those in the art, this preferred feature is not limited to MP3 files, but applies to essentially any content including streaming media files, DVD movies etc., and files that are stored on a permanent storage device such as CD-ROMs and DVD disks.

Modifications within the spirit and scope of the invention may readily be effected by persons skilled in the art. It is to be understood, therefore, that this invention is not limited to the particular embodiments described by way of example hereinabove.

The claims defining the invention are as follows:

1. A method of controlling the use of or access to electronic content, comprising the steps of:
specifying for said content a cost expressed in terms of computing units;
selling to a user a number of said computing units; and
permitting said user to use or access said content as long as said user has a positive balance of said -computing units.

2. A method as claimed in claim 1, including advising said user of said cost before permitting said user to use or access said content and, if said user has sufficient computing units to use or access said content, said method includes accepting from said user acceptance or refusal of said cost and thereby use of or access to said content, or, if said user has insufficient computing units to use or access said content, said method includes accepting from said user acceptance or refusal of said cost and selling to said user sufficient computing units to use or access said content if said user accepts said cost.

3. A method as claimed in either claim 1 or 2, including selling additional computing units to said user to increase said balance.

4. A method as claimed in any one of the preceding claims, including accepting a request from said user for said content, and providing authorization data to said user if said user has a sufficient number of said computing units to use or access said content, whereby said authorization data is useable to permit use of or access to said content.

5. A method as claimed in any one of the preceding claims, including monitoring use of or access to said content by said user by means of monitoring means in a device employed by said user to use or access said content, requesting that additional computing units be purchased if said balance is insufficient for a requested use of or access to said content, and terminating or denying said use or access when said user has an insufficient balance.

6. A method as claimed in claim 5, including transmitting authorization data to said device, wherein said device is operable to permit said use or access in response to receiving said authorization data.

7. A method as claimed in either claim 5 or 6, wherein, when said device is a computer, said monitoring means comprises software executable on said computer.

8. A method as claimed in any one of the preceding claims, including calculating said cost according to said user's previous use of said content or of other associated content.

9. A method as claimed in any one of the preceding claims, including recording, for each user, the sale of said computing units and the use of or access to any of said content.

10. A method of controlling the use of or access to electronic content, comprising the steps of:
specifying for said content a unit of usage, corresponding to either:
1) a number of uses of or accesses to said content; or
2) a net duration of use of or access to said content;
selling to a user a number of said units of usage; and
determining the available number of said units of usage available to said user;
permitting said user to use or access said content for said available number of units of usage.

11. A method as claimed in claim 10, including setting said number of units that may be ordered or paid for by said user.

12. A method as claimed in claim 10, including additionally accepting from said user a specification of a desired number of units.

13. A method as claimed in any one of claims 10 to 12, including selling additional units of usage to said user to increase said available number of units.

14. A method as claimed in any one of claims 10 to 13, including accepting a request from said user for said content, and providing authorization data to said user if said user has a sufficient number of said units of usage to use or access said content, whereby said authorization data is useable to permit use of or access to said content.

15. A method as claimed in claim 14, including transmitting said authorization data to said device, wherein said device is operable to permit said use or access in response to receiving said authorization data.

16. A method as claimed in any one of claims 10 to 15, including monitoring said use or access by means of monitoring means in a device employed by said user to use or access said content, and terminating use of or access to said content when said user has exhausted said available number of units or otherwise has insufficient units to continue said access or use.

17. A method as claimed in claim 16, wherein, when said device is a computer, said monitoring means comprises software executable on said computer.

18. A method as claimed in any one of claims 10 to 17, including calculating a cost of said use or access according to said user's previous use of said content or of other associated content.

19. A method as claimed in any one of claims 10 to 18, including recording, for each user, the sale of said units of usage and the use of or access to any of said content.

20. Computer program portions for execution by a computer to perform the method defined in any one of claims 1 to 19.

21. A computer readable medium having computer program portions for execution by a computer to perform the method defined in any one of claims 1 to 19.

22. A computer program product directly loadable into the internal memory of a computer, having software code portions for performing the steps of the method defined in any one of claims 1 to 19.

23. A computer program product stored on a computer readable medium, for causing a computer to perform the steps of the method defined in any one of claims 1 to 19.

24. A computer readable medium, having a program recorded thereon, where the program is to make a computer execute the method defined in any one of claims 1 to 19.

25. An apparatus for controlling the use of or access to electronic content, comprising:
computing means including input means for receiving from a user an order for a number of computing units, payment for said number of said computing units and a request for said use of or access to said content;
memory storage means for storing a cost of said content expressed in computing units, and for storing credit data for determining the number of said computing units available to said user;
authorization means for authorizing said use of or access to said content;
wherein said computing means is operable to receive said request, check said credit data and direct said authorization means to authorize said use of or access to said content as long as said user has a positive balance of said available computing units.

26. An apparatus as claimed in claim 25, wherein said computing means is operable to advise said user of said cost before directing said authorization means to authorize said use or access and, if said user has sufficient available computing units to use or access said content, to accept from said user acceptance or refusal of said cost and thereby use of or access to said content, or, if said user has insufficient available computing units to use or access said content, to accept from said user acceptance or refusal of said cost and sell to said user sufficient computing units to use or access said content if said user accepts said cost.

27. An apparatus as claimed in either claim 25 or 26, wherein said apparatus is operable to accept an additional order and/or payment from said user to increase said balance.

28. An apparatus as claimed in any one of claims 25 to 27, wherein said apparatus is operable to monitor use of or access to said content by said user by means of monitoring means in a device employed by said user to use or access said content, to request that additional computing units be purchased if said balance is insufficient for a requested use of or access to said content, and to terminate or deny said use or access when said user has an insufficient balance.

29. An apparatus as claimed in claim 28, wherein said apparatus is operable to transmit authorization data to said device, wherein said device is operable to permit said use or access in response to receiving said authorization data.

30. An apparatus as claimed in either claim 28 or 29, wherein, when said device is a computer, said monitoring means comprises software executable on said computer.

31. An apparatus as claimed in any one of claims 25 to 30, wherein said computing means is operable to calculate said cost according to said user's previous use of said content or of other associated content.

32. An apparatus as claimed in any one of claims 25 to 31, wherein said apparatus is operable to record, for each user, the sale of said computing units and the use of or access to any of said content.

33. An apparatus for controlling the use of or access to electronic content, comprising:
computing means including input means for receiving from a user an order for a number of units of usage of said content and/or payment for said number of said units of usage, and a request for said use of or access to said content, each unit of usage corresponding to either: 1) a number of uses of or accesses to said content; or 2) a net duration of use of or access to said content;
memory storage means for storing credit data for determining the number of said units of usage available to said user;
authorization means for authorizing said use of or access to said content;
wherein said computing means is operable to receive said request, check said credit data and direct said authorization means to authorize said use or access for said available number of units of usage.

34. An apparatus as claimed in claim 33, wherein said computing means is operable to accept said order only in respect of a predetermined number of said units of usage.

35. An apparatus as claimed in claim 33, wherein said computing means is operable to accept said order in respect of a number of said units of usage specified by said user.

36. An apparatus as claimed in any of claims 33 to 35, wherein said computer means is operable to accept an additional order and/or payment from said user to increase said available number of units.

37. An apparatus as claimed in any of claims 33 to 36, wherein said apparatus is operable to provide authorization data to said user if said user has a sufficient number of said units of usage to use or access said content, whereby said authorization data is useable to permit use of or access to said content.

38. An apparatus as claimed in any of claims 33 to 37, wherein said apparatus is operable to monitor said use or access by means of monitoring means in a device employed by said user to use or access said content, and to terminate use of or access to said content when said user has exhausted said number of units or otherwise has insufficient units to continue said access or use.

39. An apparatus as claimed in claim 38, wherein said apparatus is operable to transmit authorization data to said device, wherein said device is operable to permit said use or access in response to receiving said authorization data.

40. An apparatus as claimed in either claim 38 or 39, wherein, when said device is a computer, said monitoring means comprises software executable on said computer.

41. An apparatus as claimed in any of claims 33 to 40, wherein said apparatus is operable to calculate said a cost of said use or access according to said user's previous use of said content or of other associated content.

42. An apparatus as claimed in any of claims 33 to 41, wherein said computing means is operable to record, for each user, the sale of said units of usage and the use of or access to any of said content.

43. A method as claimed in any one of claims 1 to 19, including providing to said user said use of or access to said electronic content by means of an intermediary.

44. A method as claimed in claim 43, including paying said intermediary for providing to said user said use of or access to said electronic content.

45. A method as claimed in claim 43, including being billed by said intermediary for providing to said user said use of or access to said electronic content on the basis of computing units used by said user in the course of receiving said use of or access to said electronic content by means of an intermediary.

46. A method as claimed in claim 43, including notifying said intermediary that said user desires said use of or access to said electronic content by said user attempting to establish a connection to a server of said intermediary by means f a modified user identification information, unmodified user identification information being that user identification information used by said user when seeking use of or access to said electronic content without said intermediary.

47. A method as claimed in claim 46, wherein said modified user identification information comprises said unmodified user identification information with additional characters appended to a user name, to a password or to both a user name or to a password.

48. A method as claimed in claim 47, wherein said additional characters comprise or include characters indicative of the user's country of origin in which said unmodified user identification information is valid.

49. A method as claimed in any one of claims 1 to 19, including monitoring use of or access to said content by said user by means of monitoring means in a device employed by said user to use or access said content, by means of monitoring means contained in said content, or by means of monitoring means in said device and contained in said content.

50. A method as claimed in claim 49, including monitoring said use of or access to said content when said user is off-line, wherein said monitoring means is provided with information indicative of said balance of said computing when last said user was on-line.

51. A method as claimed in either claim 49 or 50, wherein said monitoring means comprises software portions.

52. An apparatus as claimed in any one of claims 25 to 42, operable to provide to said user said use of or access to said electronic content by means of an intermediary.

53. An apparatus as claimed in claim 52, operable to pay said intermediary for providing to said user said use of or access to said electronic content.

54. An apparatus as claimed in claim 52, operable to be billed by said intermediary for providing to said user said use of or access to said electronic content on the basis of computing units used by said user in the course of receiving said use of or access to said electronic content by means of an intermediary.

55. An apparatus as claimed in claim 52, whereby said intermediary is notified that said user desires said use of or access to said electronic content by said user attempting to establish a connection to a server of said intermediary by means of a modified user identification information, unmodified user identification information being that user identification information used by said user when seeking use of or access to said electronic content without said intermediary.

56. An apparatus as claimed in claim 55, wherein said modified user identification information comprises said unmodified user identification information with additional characters appended to a user name, to a password or to both a user name or to a password.

57. An apparatus as claimed in claim 56, wherein said additional characters comprise or include characters indicative of the user's country of origin in which said unmodified user identification information is valid.

58. An apparatus as claimed in any one of claims 25 to 42, operable to monitor use of or access to said content by said user by means of monitoring means in a device employed by said user to use or access said content, by means of monitoring means contained in said content, or by means of monitoring means in said device and contained in said content.

59. An apparatus as claimed in claim 58, operable to monitor said use of or access to said content when said user is off-line, wherein said monitoring means is provided with information indicative of said balance of said computing when last said user was on-line.

60. An apparatus as claimed in either claim 58 or 59, wherein said monitoring means comprises software portions.
